(19) United States
(12) Patent Application Publication
(10) Pub. No.: US 2006/0216680 A1
(43) Pub. Date: Sep. 28, 2006

(54) Selection of relationship improvement content for users in a relationship

(75) Inventors: J. Galen Buckwalter, Pasadena, CA (US); Gregory T. Forgatch, San Marino, CA (US); Gregory S. Smirin, Los Altos, CA (US); Neil Clark Warren, Pasadena, CA (US)

Correspondence Address: VAN PELT, YI & JAMES LLP, 10050 N. FOOTHILL BLVD #200, CUPERTINO, CA, 95014, US

(73) Assignee: eHarmony.com

(21) Appl. No.: 11/090,930

(22) Filed: Mar. 24, 2005

(51) Int. Cl. G09B 19/00

(52) U.S. Cl. 434/236

(57) ABSTRACT

A method of delivering relationship improvement content is disclosed. Psychometric data relating to a first partner and a second partner are obtained. A characteristic of the first partner is evaluated using the psychometric data relating to the first partner. A characteristic of the second partner is evaluated using the psychometric data relating to the second partner. The evaluations of the first and second partner are compared to obtain a comparative characteristic. Relationship development content is delivered to the first partner. The relationship development content delivered is application in the context of a relationship between the first partner and the second partner.

### BACKGROUND OF THE INVENTION

Partners in a relationship sometimes experience issues in various areas of their relationship that may adversely impact their relationship. For example, they may have different expectations, may be inconsiderate towards their partner or may poorly communicate. Relationship counseling is one method of developing the partners and thus improving the relationship. However, relationship counseling may be inconvenient. The partners may have to go to a counselor's office which is far from their home or work. The counselor's operating hours may conflict with the partners' home and work commitments. Relationship counseling may also be expensive.

A system to develop users as an effective partner in a relationship would be both beneficial and advantageous to the user, the partner and the satisfaction they experience in the relationship. If the user and the system were both connected to some network, then the user could access the system remotely. The system could also be constructed to be accessible at all times for the user's convenience. It would also be useful if the system was relatively inexpensive and affordable for many users.

### BRIEF DESCRIPTION OF THE DRAWINGS

Various embodiments of the invention are disclosed in the following detailed description and the accompanying drawings.

FIG. 1 is a diagram illustrating an embodiment of a system 100 for users who are interested in improving themselves as a partner in a relationship.

FIG. 2 is a diagram illustrating the queries used to collect psychometric data pertaining to a partner.

FIG. 3 is a diagram illustrating the use of simulations to collect psychometric data.

FIG. 4 is a diagram illustrating evaluation of a characteristic using a user's responses about himself.

FIG. 5 illustrates 2 distributions comparing evaluations of partners.

FIG. 6 is a diagram illustrating selection of relationship improvement content using characteristics and comparative characteristics.

FIG. 7 is a flow chart illustrating the sequence of reviewing the content.

FIG. 8 illustrates the forms relationship improvement content may take.

FIG. 9 is an illustration of the initial and current comparative characteristics presented to the user.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A system to distribute relationship improvement content is disclosed. The system and user exchange information through one or more communication channels. Psychometric data is collected about the partners regarding themselves as individuals or in the context of the relationship. This data is used to characterize each of the partners against empirical data previously collected from a multitude of subjects. In general this is performed for each partner across multiple aspects. In some embodiments the characteristic is an approximation of a partner's satisfaction. The partners' characteristics are then compared to one another to obtain a comparison characteristic. The comparison characteristic may be obtained for more than one aspect. Based on some combination of characteristics and comparison characteristics, content to improve the relationship is selected. Each user reviews the content to improve herself as a partner in the relationship. After the user reviews the content, further collection of psychometric data and content delivery follow.

For the purpose of example, a relationship improvement system is described in detail below. Users of the system are two people in a preexisting romantic relationship in this embodiment. In some embodiments, one spouse may be a user of the service while the other spouse does not participate. In some embodiments, the nature of the relationship may be a non-romantic relationship. Families, friends, or coworkers are some groups of people who may be users of the service. The users of the service are one or more people. In some embodiments, the user is currently not in a relationship and a simulated relationship is created by the service. For example, two users of the service with no preexisting connection jointly participate to improve themselves with practice partners. A user may also participate with a simulated partner. A user is someone who employs the relationship improvement service while a partner is someone in a relationship. Potentially, someone is a partner but not a user (for example, the absent spouse), or a user is not a partner in an actual relationship (for example, the user in a simulated relationship). These are examples of the users and are not meant to be exhaustive.

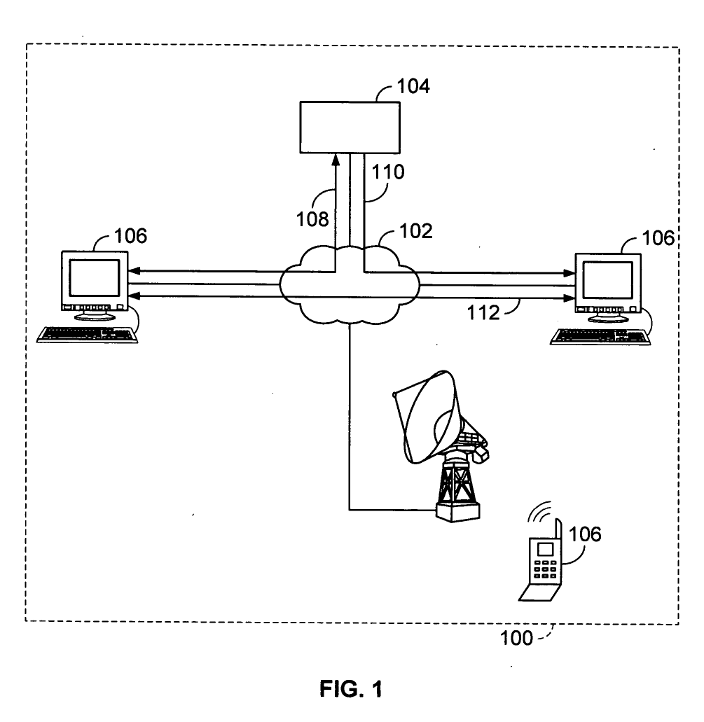

FIG. 1 is a diagram illustrating an embodiment of a system 100 for users who are interested in improving themselves as a partner in a relationship. The system 100 includes a network 102 providing communication between a relationship development service 104 and one or more remote units 106. The relationship improvement service 104 can include one or more processing units for communicating with the remote units 106. The processing units include electronics for performing the methods and functions described in this application. In one embodiment, the processing units include a neural network. Suitable remote units 106 include, but are not limited to, desktop personal computer, workstation, telephone, cellular telephone, personal digital assistant (PDA), laptop, or any other device capable of interfacing with a communications network. Suitable networks 102 for communication between the server and the remote units 106 include, but are not limited to, the Internet, an intranet, an extranet, a virtual private network (VPN) and non-TCP/IP based networks 102. Some embodiments are not implemented as a network. For example, if the service is implemented as a software program and sold, the user and service would be collocated.

A user at remote unit 106 and the relationship improvement service 104 can communicate as shown by the arrow labeled 108. Examples of communications include exchange of electronic mail, web pages and answers to inquiries on web pages. A user at another remote unit 106 can also communicate with the relationship improvement service as indicated by the arrow labeled 110. One user can also communicate directly with another user as shown by the arrow labeled 112. The methods described in this embodiment can be performed using the communications illustrated by 108, 110 and 112. However, other forms of communication can be used including normal mail services, phone calls and directly visiting the relationship improvement service.

There are many mechanisms to collect psychometric data about partners in a relationship. Some embodiments use queries to collect psychometric data. Some embodiments use simulations. In some embodiments, multiple mechanisms are used to collect psychometric data. Queries and simulations are not the only mechanisms to obtain psychometric data. Puzzles and games are used in some embodiments. These are a few examples of the mechanisms used to collect psychometric data.

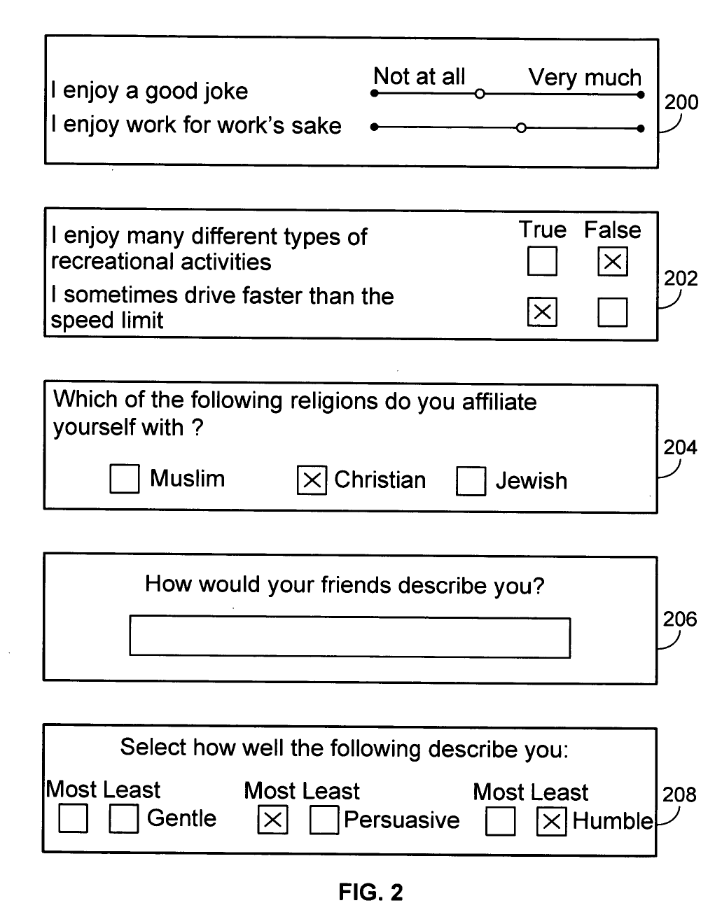

FIG. 2 is a diagram illustrating the queries used to collect psychometric data pertaining to a partner. With query 200 the responder sets a sliding scale according to their response. Query 202 asks the responders to select true or false. This could also be implemented as a yes or no question. Query 204 asks the responder to select from a list. In some embodiments the responder is allowed to select more than one response. Responders reply to query 206 with an open ended response. The content and format are not predefined by the system in some embodiments. The responder is asked to write a description, draw a sketch, or role play. Query 208 asks responders to rank items. Although this embodiment ranks only the highest and lowest items, other embodiments rank all items, only the top items, or only the bottom items. These are some examples of queries used to obtain psychometric data about a partner.

In some embodiments, there are two responders to the queries and they are the users of the relationship improvement service. Sometimes there is only one user and that user responds in place of their partner to obtain psychometric data pertaining to the absent partner. In some embodiments, a responder is not one of the partners in the relationship. It may be an ex-girlfriend, a friend, a co-worker or close relation. A non-partner responder may be in addition to or in place of one of the partners. Responders to queries about a given partner are not limited to that partner.

Selection and administration of the queries to the responders varies according to the embodiment. In some embodiments, the queries administered to the responders are different. Conversely, in some embodiments the same queries are administered. The responders may simultaneously review the queries and provide a single response, or they may review the queries independently. An adaptive process is applied in some embodiments to select the queries. An initial set of responses to queries are evaluated and based on the evaluation a subsequent set of queries are selected and administered. In some embodiments the user indicates areas of their relationship to improve and queries relating to that area are selected. These are some examples of how the queries are selected and administered.

The queries pertain to a partner as an individual or within the context of the relationship. As described above, a user is someone who uses the relationship improvement service. A partner refers to someone in a relationship. Sometimes a partner is also a user (for example, if both people in a relationship use the relationship improvement service both are partners as well as users) and sometimes a partner is not a user (for example, a person who does not use the relationship development service but whose spouse does). Query 200 asks the responder to rate how well the statement “I enjoy a good joke” applies to a partner. This pertains to a partner as an individual. The statement “My partner and I laugh at the same jokes” pertains to a partner within the context of the relationship. In this embodiment there are 29 individual factors and 10 relationship categories for which the partners are evaluated. The individual factors and relationship categories are more generally referred to as aspects. An individual factor is one aspect of a partner as an individual. A relationship category is one aspect of a partner in the context of the relationship. Each of the individual factors and relationship categories has queries associated with them. In this embodiment, the queries are only associated with one individual factor or relationship category. The queries for the 29 individual factors and 10 relationship categories are used to evaluate multiple characteristics of the partners and the relationship.

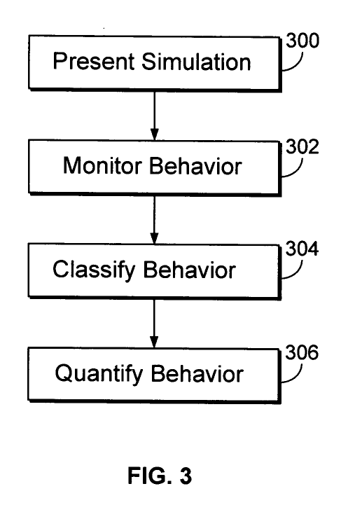

FIG. 3 is a diagram illustrating the use of simulations to collect psychometric data. In this embodiment, the user is the participant and is in a virtual social setting. The user enters a virtual social setting and employs an avatar to interact with simulated people. After the simulation is presented to the user (300), some entity in the relationship improvement service monitors the user's behavior (302). This entity may be a person or some automated device. The monitoring entity then classifies the user's behavior (304). For example, based on the user's behavior the monitoring entity identifies an individual characteristic to which the behavior relates. Then, the monitoring entity quantifies the individual characteristic (306). For example, if the individual characteristic is persistence, the monitoring entity quantifies the amount of persistence the user's behavior demonstrates. This process continues until the simulation ends. In some embodiments, multiple users of the service simultaneously interact in the simulation. The simulation environment may be a virtual environment or the users may interact in person. Collecting psychometric data from a simulation is more sophisticated than collecting data from a query. Some embodiments improve on the method by improving classification of behavior or improving selection of the simulation scenarios.

The psychometric data about a partner is quantized for the relationship improvement service to work with in this embodiment. The possible responses to query 200 and queries 204 through 208 of FIG. 2 are assigned values. For open-ended queries, some embodiments employ a behavioral expert to quantify responses while other embodiments automate this process. Methods to improve the process of obtaining psychometric data using a simulation are applied in various embodiments. Other embodiments, which employ a more sophisticated processing system at the relationship improvement service, do not need to quantize the psychometric data. In this embodiment the psychometric data is quantized so the processing system can process the data.

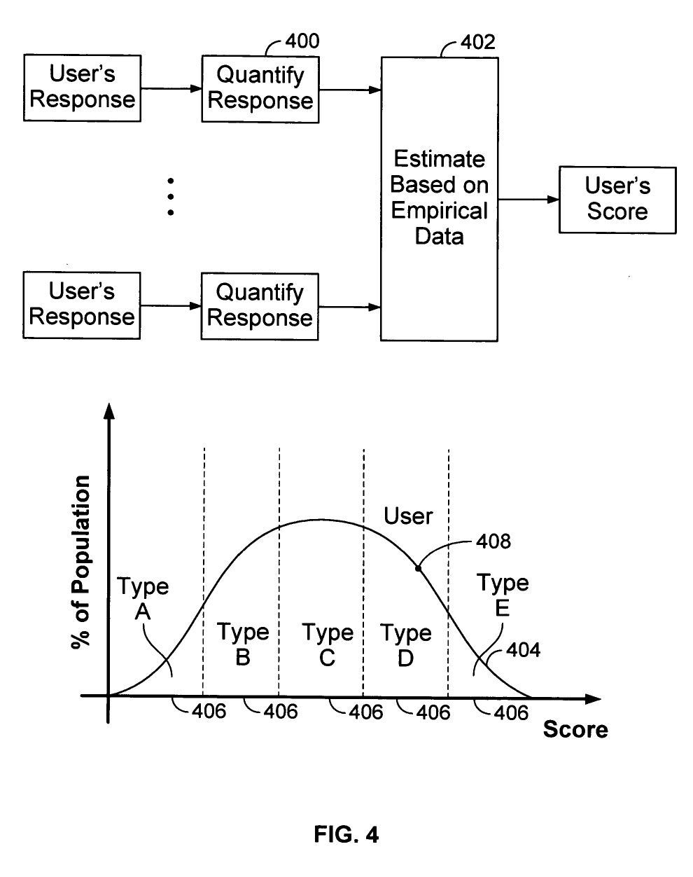

FIG. 4 is a diagram illustrating evaluation of a characteristic using a user's responses about himself. In this embodiment, the user responded to queries about himself. In some embodiments responses from someone else besides a user are utilized. The user's responses are quantized (400) and then a score is estimated (402) for each aspect. In this embodiment each aspect has queries associated with it, and those queries are used to estimate the score for that aspect. Based on empirical data previously collected from a multitude of test subjects, a distribution (404) is created for this aspect. In this embodiment, 5 generalized types (406) are defined within the distribution. People who fall within the same type share similar traits for that aspect. Rather than working with an infinite number of types, the relationship improvement service only has to work with 5. This simplifies creation and selection of content for a relationship improvement service that has many users. In this example, the user is of Type D (408) because of the user's score and the range of scores for Type D.

The psychometric data used to evaluate a partner is collected from a variety of sources. In some embodiments, the evaluation for an absent partner utilizes psychometric data collected from users on behalf of their absent partner. In some embodiments, the user is instructed to select the response that is the most accurate description of their partner. In some embodiments, the user is instructed to respond as if they were their partner. Embodiments with non-partner responders may incorporate that data as well. Collection of psychometric data used for characteristic evaluation is not limited to data collected from the partner in question. Rather, the psychometric data about the partner in question may be collected from a variety of responders.

In this embodiment, the scores approximate a partner's satisfaction in an aspect. The types are therefore generalizations of satisfaction levels for that aspect. For example, one partner may be very satisfied in a relationship category while the other partner is moderately satisfied. In some embodiments, the scores estimated are not measures of satisfaction. The scores may represent how much or how little an aspect is representative of a partner. The scores in some embodiments are a measurement of how much a partner values those aspects in herself and her relationship. In some embodiments the scores represent different things for each aspect. For each individual factor or relationship category, the partner is assigned to one of the 5 types based on their score and the range of scores for the 5 types. This process is repeated for each of the partners for each of the aspects. The score for a partner for an aspect can more generally be called a characteristic. Since the collected psychometric data pertains to a partner as an individual or in the context of the relationship, characteristics likewise apply to a partner as an individual or within the context of the relationship. Characteristics do not consider the psychometric data collected for the other partner.

In some embodiments, the empirical data is collected using queries asking subjects about themselves and their relationships. Some of the queries ask subjects to rate their satisfaction in their relationships. The set of queries or even the method to collect the empirical data may change over time. In some embodiments, collection of empirical data is ongoing and the subjects are not users of the relationship improvement service. These are some example of collecting empirical data and are not exhaustive.

To estimate a partner's score, an estimation function is created and applied. In this embodiment, a function is created based on the empirical data, where the inputs to the function are the quantized responses (excluding those pertaining to satisfaction) and the output is a score approximating satisfaction. This function may be a matrix, a neural network or a linear combination of terms. In some embodiments, algorithms are applied to best fit the estimation function to the empirical data. Parameters are adjusted so if empirical inputs are entered, the estimation function outputs an approximation of the empirical output. In some embodiments there is an estimation function for each individual factor or relationship characteristic. An estimation function to generate a score from quantized responses is thus created and used.

Aspects in this embodiment, either pertaining to the individual or within the context of the relationship, are a fixed and predefined set. This embodiment will evaluate all partners across the same 10 relationship categories and 29 individual factors. In some embodiments, the aspects are selected from a predefined set and are a subset of all possible aspects. For example, the relationship improvement service selects 3 aspects for the user to focus on. In some embodiments the user is allowed to select aspects to improve. Evaluating a subset may reduce the amount of content selected which the user will review. Using a subset may also result in selecting content that has the most incremental benefit to the partners. This may be useful in an application where users want to improve their relationship at an accelerated rate. In general, the partners are evaluated across a set of aspects.

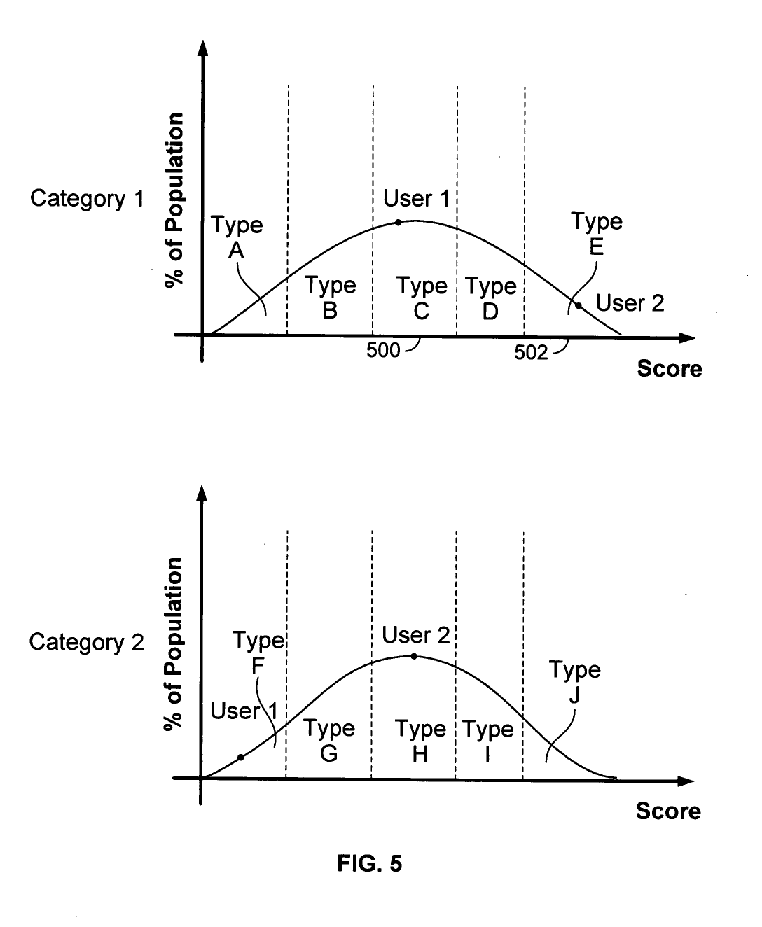

FIG. 5 illustrates 2 distributions comparing evaluations of partners. After the partners are evaluated, the characteristics are compared against each other. In this example, User 1 is Type C (500) and User 2 is Type E (502) in Category 1. However, in Category 2, User 1 is Type F and User 2 is type H. In this example, people who are Types C and H have normative levels of satisfaction. A comparative characteristic is obtained in this embodiment by comparing the characteristics of the partners. A comparative characteristic may be conceptualized as a two dimensional number. For example, the comparative characteristic of Category 1 is (Type C, Type E). Some embodiments do not differentiate between (Type C, Type E) and (Type E, Type C). A characteristic pertains to one partner, either individually or as a partner, while a comparative characteristic pertains to both partners either as individuals or as partners. Some combination of characteristics and comparative characteristics are used to select the relationship improvement content.

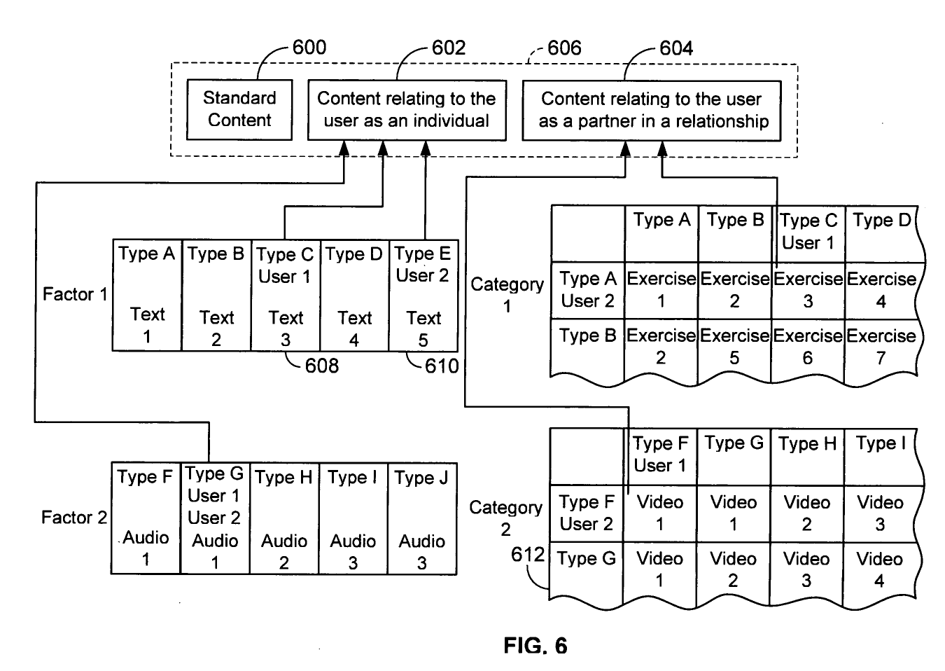

FIG. 6 is a diagram illustrating selection of relationship improvement content using characteristics and comparative characteristics. In this embodiment, the content is divided up into three portions: standard content (600), individual content relating to the user as an individual (602), and relationship content relating to the user as a partner in the relationship (604). Together they comprise relationship improvement content (606) in this example. All users in this embodiment review the same standard content. Individual content is selected based on the characteristics of individual factors in this example. In other words, individual content is selected based on only that partner's evaluations from psychometric data about themselves as an individual. Some embodiments use the comparative characteristic and consider both partners. As FIG. 6 illustrates, User 1 is Type C for Factor 1. Text 3 (608) is therefore selected and Text 5 (610) is selected for User 2. This embodiment employs multiple lookup tables to select content.

In this embodiment, relationship content is selected using comparative characteristics. That is, the evaluations of both partners are considered in selecting relationship improvement content. In this embodiment the relationship content is selected based on the difference between the two partner's evaluations as well as the difference between their evaluation and the norm. The content for Type A and B partners would thus be different than content for Type D and E partners. Although both examples are only 1 type away from each other, they are different extremes of the normative. Relationship content also reflects how far apart two partners are in terms of type. The content for two partners who are the same type will be different than content for partners who are different extremes. In this example, the lookup tables for each relationship category are unique and content may be selected in more than one instance. For example, in lookup table 612, Video 1 is selected if both users are Type F, or if one is Type F and the other is Type G. Some embodiments organize their lookup tables differently. Relationship content is thus created and organized to address a specific comparative characteristic.

There are other variations to relationship improvement content. Some embodiments select different content for the partners to review. Some embodiments do not include individual content for the user. In some embodiments the delivery method of the content is in-person. In some embodiments the delivery method of the content is via a website. These are some examples of relationship improvement content and its delivery to the user.

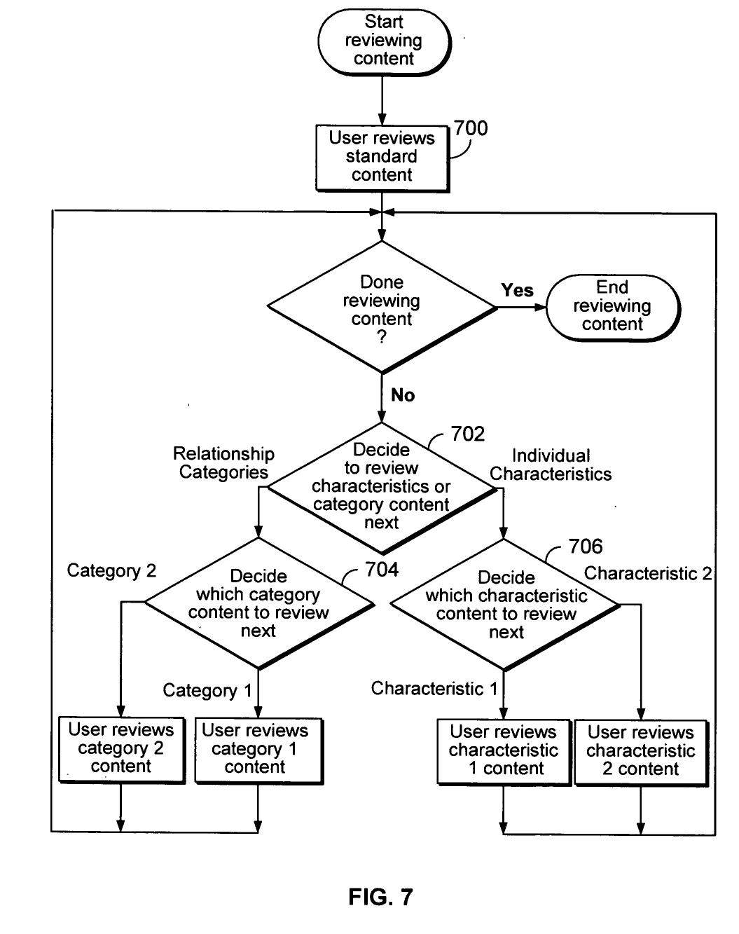

FIG. 7 is a flow chart illustrating the sequence of reviewing the content. In this embodiment the user first reviews standard content (700). Standard content may give an overview of the process and what the user should expect next. After reviewing the standard content, the user decides to review individual content or relationship content next (702). In some embodiments, the relationship improvement service forces the user to review individual content first. If relationship content is selected, then the user selects a category to review (704) and reviews the content. If individual content is selected, then the user selects a factor to review (706) and reviews the content. Some embodiments require the user to follow a specified sequence of review. The specified sequence may be time driven or event driven. For example, the service may not allow the user to review some portions of the content for the first month. The relationship improvement service may also require content A to be reviewed before content B may be reviewed. If the content is the same for the users, some embodiments have the users review the content at the same time.

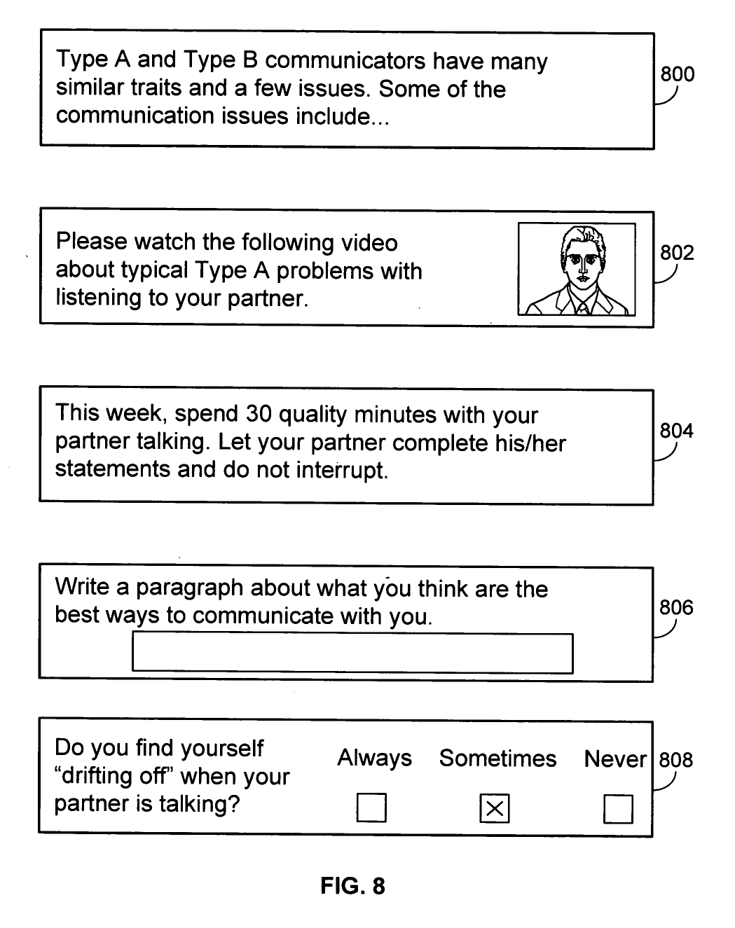

FIG. 8 illustrates the forms relationship improvement content may take. Content 800 is text describing the similarities and issues Type A and Type B users have. Content may also be video, as is content 802. Content 804 is an exercise asking the user to spend time talking with their partner. Sometimes the content is an open-ended writing exercise as is content 806. Content 808 is a question asking the user to rate how often a description applies to them. As contents 806 and 808 illustrate, in some embodiments the user returns information to the relationship improvement service. The service in some embodiments makes additional decisions based on the returned information. These are some example of the forms relationship improvement content may take.

Three months after the user begins using the service, a subsequent round of psychometric data collection and evaluation is performed in this embodiment. Different collection and evaluation methods may be employed in the subsequent round. For example, initially a simulation is used to collect data but subsequently a set of queries is used. Some embodiments employ the same methods but subsequently administer a different implementation of the method. For example, the set of queries administered is different. A combination of the initial psychometric data and current psychometric data is used to evaluate characteristics for the individual factors and relationship categories. In this embodiment only the current psychometric data is used for characteristic evaluation. After evaluation, the comparison characteristic is obtained using the current evaluations. The service then makes the initial results and current results available to the user. Improvement is thus quantified and demonstrated to the user. Positive feedback to the user may encourage and motive the user to continue developing their relationship.

In some embodiments, subsequent collection of psychometric data and evaluation is an ongoing process. Rather than subsequently collecting and reevaluating one time after the user begins, some embodiments continuously do this. For example, the user may review some content for a relationship category and then be reevaluated for that category. They then review other improvement content. Some embodiments subsequently collect psychometric data and reevaluate on an event driven basis while some embodiments do this on a time driven basis. These are some examples and are not exhaustive of how the service subsequently collects psychometric data and reevaluates the user.

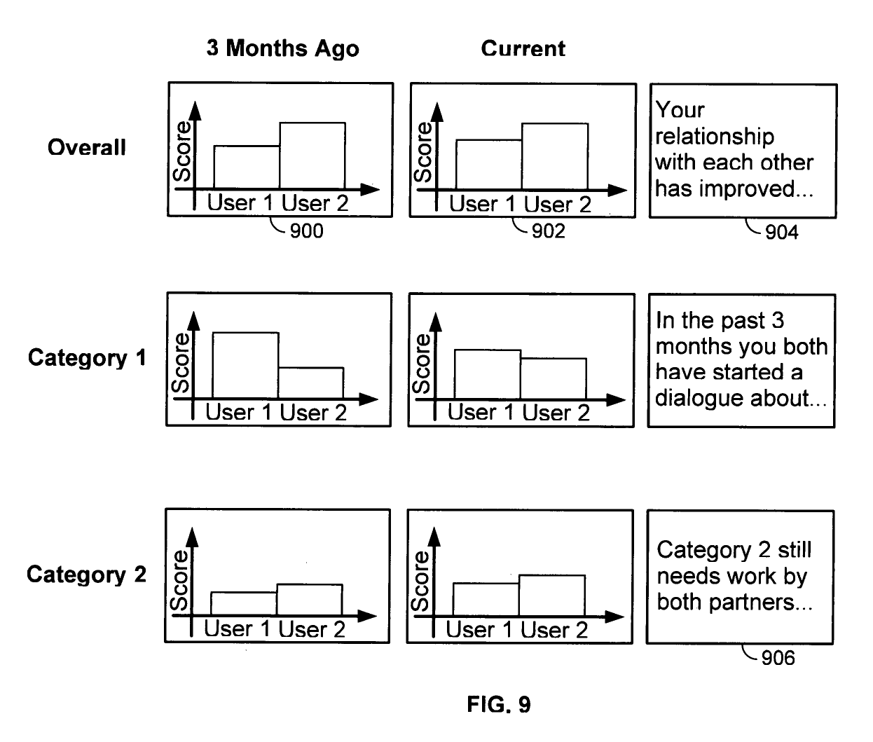

FIG. 9 is an illustration of the initial and current comparative characteristics presented to the user. Chart 900 shows an initial comparative characteristic of the partners. A score is assigned to each partner and charted. In this example, the score is an approximation of each partner's satisfaction with the relationship. Chart 902 shows a current comparative characteristic of the partners. Again, a score is assigned to each partner and charted. Additional content 904 is selected and delivered to users. Some combination of the initial and current comparative characteristics is used to select the additional content. In some embodiments additional content is selected based on the change in the comparative characteristic. For example, two partners are moderately dissatisfied with their relationship but initially were extremely dissatisfied. Additional content 904, “your relationship with each other has improved . . . ” may be selected. In some embodiments additional content is selected based on the current comparative characteristic. If two partners initially were moderately dissatisfied and still are, additional content 906, “Category 2 still needs work by both partners . . . ” may be selected. The purpose of the additional content in some embodiments is to provide commentary on the initial and current comparative characteristics. In some embodiments the purpose is to develop the user even more. Content may encourage users to continue improvement of their relationship. The service may constantly track the development of the user after the relationship development content is delivered or do it at once.

Although the foregoing embodiments have been described in some detail for purposes of clarity of understanding, the invention is not limited to the details provided. There are many alternative ways of implementing the invention. The disclosed embodiments are illustrative and not restrictive.

1. A method of delivering relationship improvement content, including:
obtaining psychometric data relating to a first partner;
obtaining psychometric data relating to a second partner;
evaluating a characteristic of the first partner using the psychometric data relating to the first partner;
evaluating a characteristic of the second partner using the psychometric data relating to the second partner;
comparing the evaluations of the first partner and second partner to obtain a comparative characteristic; and
delivering the relationship improvement content to the first partner wherein the relationship improvement content is applicable in the context of a relationship between the first partner and second partner.

2. A method as recited in claim 1, wherein the relationship is simulated.

3. A method as recited in claim 1, wherein the relationship is romantic.

4. A method as recited in claim 1, wherein the psychometric data of the second partner is based on information provided by the first partner.

5. A method as recited in claim 1, wherein the psychometric data of the second partner is based on information provided by someone other than the first partner or second partner.

6. A method as recited in claim 1, wherein the psychometric data is obtained using a query.

7. A method as recited in claim 1, wherein the psychometric data is obtained using a puzzle.

8. A method as recited in claim 1, wherein the psychometric data is obtained using a simulation.

9. A method as recited in claim 1, wherein the psychometric data is obtained using a same questionnaire for the first partner and the second partner.

10. A method as recited in claim 1, wherein the psychometric data is obtained using a different questionnaire for the first partner and the second partner.

11. A method as recited in claim 1, wherein the psychometric data is obtained using a same simulation for the first partner and the second partner.

12. A method as recited in claim 1, wherein the psychometric data is obtained using a different simulation for the first partner and the second partner.

13. A method as recited in claim 1, wherein the psychometric data is obtained using an adaptive method.

14. A method as recited in claim 1, wherein the psychometric data is obtained via a network.

15. A method as recited in claim 1, wherein the characteristic of the first partner and the characteristic of the second partner pertain to individual factors.

16. A method as recited in claim 1, wherein the characteristic of the first partner and the characteristic of the second partner are the relative satisfactions of the first partner and the second partner in the context of a relationship.

17. A method as recited in claim 1, wherein the characteristic of the first partner and the characteristic of the second partner are the relative satisfactions of the first partner and the second partner in the context of a relationship in a plurality of aspects.

18. A method as recited in claim 1, wherein the characteristic of the first partner and the characteristic of the second partner are in a selected aspect.

19. A method as recited in claim 1, wherein the comparative characteristic is the relative satisfaction of the first partner and the second partner in the relationship.

20. A method as recited in claim 1, wherein the comparative characteristic is the relative satisfaction of the first partner and the second partner in a plurality of aspects.

21. A method as recited in claim 1, wherein the comparative characteristic is in a selected aspect.

22. A method as recited in claim 1, wherein evaluating a characteristic includes comparison against normative data.

23. A method as recited in claim 1, wherein evaluating a characteristic includes generalization.

24. A method as recited in claim 1, wherein the relationship development content is delivered separately to the first partner and the second partner.

25. A method as recited in claim 1, wherein the relationship development content is different for the first partner and the second partner.

26. A method as recited in claim 1, wherein the relationship development content is delivered jointly to the first partner and the second partner.

27. A method as recited in claim 1, wherein the relationship development content includes individual content.

28. A method as recited in claim 1, wherein the relationship development content includes a video.

29. A method as recited in claim 1, wherein the relationship development content includes an exercise.

30. A method as recited in claim 1, wherein the relationship development content is processed in a specified sequence.

31. A method as recited in claim 1, wherein the relationship development content is delivered via a network.

32. A method as recited in claim 1, further including:
obtaining additional psychometric data after delivering relationship development content; and
providing further relationship development content.

33. A system for delivering relationship improvement content, including: a collector configured to:
obtain psychometric data relating to a first partner; and
obtain psychometric data relating to a second partner; a processor configured to:
evaluate a characteristic of the first partner using the psychometric data relating to the first partner;
evaluate a characteristic of the second partner using the psychometric data relating to the second partner; and
compare the evaluations of the first partner and second partner to obtain a comparative characteristic; and
a delivery system to deliver the relationship improvement content to the first partner wherein the relationship improvement content is applicable in the context of a relationship between the first partner and second partner.

34. A system as recited in claim 33, wherein the psychometric data of the second partner is based on information provided by someone other than the first partner or second partner.

35. A system as recited in claim 33, wherein the psychometric data is obtained using a same questionnaire for the first partner and the second partner.

36. A system as recited in claim 33, wherein the characteristic of the first partner and the characteristic of the second partner are the relative satisfactions of the first partner and the second partner in the context of a relationship.

37. A system as recited in claim 33, wherein the comparative characteristic is the relative satisfaction of the first partner and the second partner in the relationship.

38. A system as recited in claim 33, wherein evaluating a characteristic includes comparison against normative data.

39. A system as recited in claim 33, wherein the relationship development content includes a video.

40. A system as recited in claim 33, wherein:
the collector is further configured to obtain additional psychometric data after delivery of the relationship development content; and
the delivery system is further configured to provide further relationship development content.

41. A computer program product for delivering relationship improvement content, the computer program product being embodied in a computer readable medium and comprising computer instructions for:
obtaining psychometric data relating to a first partner;
obtaining psychometric data relating to a second partner;
evaluating a characteristic of the first partner using the psychometric data relating to the first partner;
evaluating a characteristic of the second partner using the psychometric data relating to the second partner;
comparing the evaluations of the first partner and second partner to obtain a comparative characteristic; and
delivering the relationship improvement content to the first partner wherein the relationship improvement content is applicable in the context of a relationship between the first partner and second partner.

42. A computer program product as recited in claim 41, wherein the psychometric data of the second partner is based on information provided by someone other than the first partner or second partner.

43. A computer program product as recited in claim 41, wherein the psychometric data is obtained using a same questionnaire for the first partner and the second partner.

44. A computer program product as recited in claim 41, wherein the characteristic of the first partner and the characteristic of the second partner are the relative satisfactions of the first partner and the second partner in the context of a relationship.

45. A computer program product as recited in claim 41, wherein the comparative characteristic is the relative satisfaction of the first partner and the second partner in the relationship.

46. A computer program product as recited in claim 41, wherein evaluating a characteristic includes comparison against normative data.

47. A computer program product as recited in claim 41, wherein the relationship development content includes a video.

48. A computer program product as recited in claim 41, the computer program product further comprising computer instructions for:
obtaining additional psychometric data after delivering relationship development content; and
providing further relationship development content.
